(19) United States
(12) Patent Application Publication
(10) Pub. No.: US 2005/0034147 A1
(43) Pub. Date: Feb. 10, 2005

(54) Remote presence recognition information delivery systems and methods

(76) Inventors: Robert E. Best JR., Atlanta, GA (US); James C. Bedingfield SR., Lilburn, GA (US)

Correspondence Address: BAMBI FAIVRE WALTERS, PO BOX 5743, WILLIAMSBURG, VA, 23188, US

(21) Appl. No.: 10/026,835

(22) Filed: Dec. 27, 2001

(51) Int. Cl. H04N 7/16; H04H 9/00

(52) U.S. Cl. 725/10; 725/12

(57) ABSTRACT

Embodiments of the present invention relate to systems and methods for remote presence recognition information delivery. In an embodiment, the system includes an information delivery system. A remote presence detector is coupled to the information delivery system and is configured to send a presence indicator to the information delivery system. The information delivery system is configured to take an information delivery action based at least in part on the presence indicator.

### BACKGROUND OF THE INVENTION

1. Field of the Invention

Embodiments of the present invention relate to information delivery systems and methods. More particularly, embodiments of the present invention relate to remote presence recognition information delivery systems and methods.

2. Background Information

Known information delivery systems typically deliver information in response to an active request for information. An example of an information delivery system is a personal computer executing a web browser that requests information from a network address. FIG. 1 is an illustration of known display of information from a network address. Web browser 100 includes an address field 110 and a refresh button 120 and can be executed by a computer. After a user has entered a network address —e.g., http://bellsouthcorp.com/newsroom/—the web browser can send a request for information to the network address.

A server at the network address can receive the request and send information to the web browser 100, and the computer can display the information via web browser 100. FIG. 1 shows web browser 100 displaying a web page listing a plurality of headlines 130 including a date field 131 and a title field 132. After the server has sent the information to the web browser, the server typically does not send any additional information until that additional information is requested. Such a server is often described as operating in a pull mode because a client (e.g., a web browser) pulls information from the server via requests for the information. A disadvantage with servers that operate in a pull mode is that a user typically must request updating of information to get the latest or most current information by, for example, manually selecting and activating a refresh button 120. In an embodiment in which the computer includes a microphone and voice recognition software, the user can request updating of information by uttering a refresh command.

An alternative known technology for sending information to users is push technology. A server that is using push technology can send updated information automatically to a client. For example, a user can register with a push server to indicate what types of information the user wants pushed to his computer. Then, the server will periodically send updated information to the user's computer. A disadvantage of push technology is that it can overload or degrade the performance of a network when many users of the network are receiving pushed information. For example, a corporation can have multitudes of employees that are receiving pushed information, and the transmission of that pushed information can degrade operation of the corporation's network. Moreover, when information is periodically pushed to a user, network resources will be consumed by delivering that information to the user even though the user may be away from his computer (e.g., at a meeting, out to lunch, out of the office, etc.). In view of the foregoing, it can be appreciated that a substantial need exists for systems and methods that can advantageously provide for remote presence recognition information delivery.

### BRIEF SUMMARY OF THE INVENTION

Embodiments of the present invention relate to remote presence recognition information delivery systems and methods. In an embodiment, the system includes an information delivery system. A remote presence detector is coupled to the information delivery system and is configured to send a presence indicator to the information delivery system. The information delivery system is configured to take an information delivery action based at least in part on the presence indicator.

According to another embodiment of the present invention, a system for remote presence recognition information delivery includes an information delivery system that contains a processor and a memory. The memory stores user profile data and a plurality of instructions configured to be executed by the processor. The plurality of instructions include presence detector instructions. The remote presence recognition information delivery system also includes a remote presence detector coupled to the information delivery system. The remote presence detector is configured to send a presence indicator to the information delivery system. The information delivery system is configured to take an information delivery action based at least in part on the presence indicator and the user profile data.

In a further embodiment of the present invention, a method of remote presence recognition information delivery includes operating a remote presence detector coupled to an information delivery system. The method determines that a user is in the vicinity of the information delivery system based at least in part on receiving a presence indicator from the remote presence detector. User profile data is accessed, where the user profile data includes one or more information delivery action records. An information delivery action record is identified based at least in part on the presence indicator. An information delivery action is executed based at least in part on the identified information delivery action record.

In another embodiment of the present invention, a method of delivering information includes storing user profile data. The user profile data includes one or more information delivery action records. The method determines that a first user is at a first location in the vicinity of an information delivery system, where the first location is remote from the information delivery system. A presence indicator is received from a remote presence detector, where the remote presence detector is coupled to the information delivery system. A first information delivery action record is identified based at least in part on the presence indicator. A first information delivery action is executed based at least in part on the first information delivery action record.

### BRIEF DESCRIPTION OF THE DRAWINGS

FIG. 1 is an illustration of known display of information from a network address.

FIG. 2A is a schematic diagram illustrating an embodiment of the present invention.

FIG. 2B is a schematic diagram illustration another embodiment of the present invention.

FIG. 3 is a schematic diagram of a keyboard including a presence detector.

FIG. 4 is a schematic diagram of a mouse including a presence detector

FIG. 5 is a schematic diagram of a video display including a presence detector.

FIG. 6 is a schematic diagram of a computer including a presence detector.

FIG. 7 is a schematic diagram of a portable computer including one or more presence detectors

FIG. 8 is a schematic diagram of embodiments of the present invention.

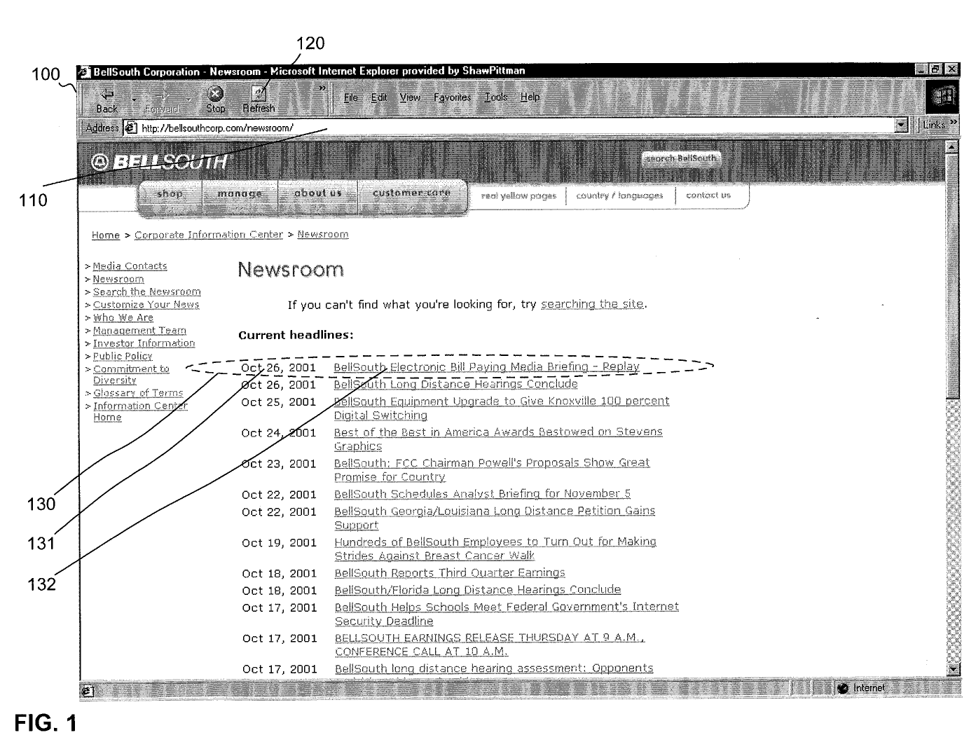

### DETAILED DESCRIPTION OF THE INVENTION

According to an embodiment of the present invention, an information delivery system can detect the presence of a user and deliver updated information to the user. For example, a computer can include a web browser to display identified information and a presence detector. A user can configure the web browser to request and display the identified information (e.g., a web page, a stock quote, a video image, etc.) when the computer determines that a user is present in the vicinity of the computer. When the presence detector determines that a user is present, it sends an indication to the computer regarding the presence of the user. The indication regarding the presence of the user can indicate a person is present although the identity of the person is not known. In another embodiment, the indication regarding the presence of the user can indicate the identity of the person that is present. After the computer receives the indication that the user is present, the computer can indicate to the web browser that the user is present, and the web browser can request the information identified by the user. Accordingly, when the user returns to his computer, the identified information displayed to the user is a most recent or current version of the identified information.

Examples of additional information delivery systems in accordance with embodiments of the present invention include televisions, radio receivers, stereos, video systems, audio systems, audio-video systems, and so on. For example, a television can be coupled to a set-top box (e.g., a cable set-top box, a High Definition TeleVision (“HDTV”) set-top box, a satellite set-top box, etc.) that receives audio-video information such as television channels, radio channels, and so on. The set-top box can be coupled to a presence detector. The set-top box can be configured to take certain actions when the presence of a user (e.g., an unidentified user, an identified user, and so on) is detected. For example, the set-top box can be instructed to turn on the television, tune to a specified channel, and adjust the volume of the television when the presence of a user is detected. In another embodiment, the set-top box can take certain actions based on the time a person is detected. For example, when a user is detected in the early morning hours of a weekday, the set-top box can tune to a traffic channel. When the user is detected during the evening news hour, the set-top box can tune to a specific news channel (e.g., ABC, CBS, NBC, CNN, Fox News, MSNBC, etc.). As a further example, when the user is detected within a time period of a specific day, the set-top box can tune to a specific channel so that television shows a specific sitcom, drama, news program, and so on.

Embodiments of the present invention can include a presence detector that does not discriminate between different users. For example, a presence detector can include an ultrasonic or infrared motion detector to determine that a user is within a vicinity, but the presence detector cannot discriminate between a first user and a second user (e.g., a sister and a brother). An example of a motion detector is a passive infrared presence detector. Known passive infrared presence detectors are used to control, among other things, automatic lighting. Another example of a motion detector is an ultrasonic motion detector that can detect a Doppler shift from a moving object. Certain ultrasonic detectors can be overly sensitive and detect transients such as cats and curtains moving in a draft, but a typical office environment and many household environments do not have cats or curtains. Another example of a presence detector is a detector than uses a narrow beam microwave system that scans an area such as a doorway or an area in the vicinity of an information delivery system. A further example of a presence detector is a video camera device (e.g., having a charge coupled device (“CCD”) chip, etc.) that can analyze video images to determine whether a user is present (e.g., by determining that a user is moving within the image area viewed by the video camera device).

In other embodiments of the present invention, a presence detector can be an identification detector that discriminates between different users. For example, a user may be associated with a radio frequency identification (“RFID”) system that can identify the user. Examples of known RFID systems include short range RFID systems, long range RFID systems, and so on. The user can carry a personal tag (e.g., a transponder) that identifies the user to a RFID reader when the user is within range of the reader. The personal tag can be activated by a signal from a reader and then communicate back to the reader. The personal tag can receive power from the activation signal or from an on-board power supply (e.g., a battery). A further example of an identification detector is a video camera device coupled to visual identification logic that can analyze video images (e.g., moving images, still images, etc.) to determine the identity of a user (e.g., by recognizing the face of a user, facial characteristics of a user, physical characteristics of a user, an infrared characteristic and/or profile of a user, etc.). Another example of an identification detection system includes wireless LAN technology. A user can carry a wireless LAN device that can communicate with a LAN hub (e.g., an 802.11b LAN hub, a Bluetooth hub, and so on).

As described herein, embodiments of the present invention range from relatively focused systems to relatively complex systems. An example of a relatively focused system in accordance with an embodiment of the present invention is a keyboard (e.g., an after-market keyboard, an original equipment manufacturer (“OEM”) keyboard, a computer keyboard, a web appliance keyboard, etc.) that includes a presence detector that sends a signal (e.g., a “ctrl-r” to refresh a screen or application) via the keyboard when a person is detected to be in the vicinity of the keyboard. An example of a relatively complex system in accordance with an embodiment of the present invention includes remote identity detectors (e.g., RFID detectors) that can identify the identity of persons, a plurality of information delivery systems (e.g., an audio information delivery system, a data delivery system, an audio-video information delivery system, etc.), and user profile data to determine a particular information delivery action to be taken when a person is identified in the vicinity of a particular information delivery system.

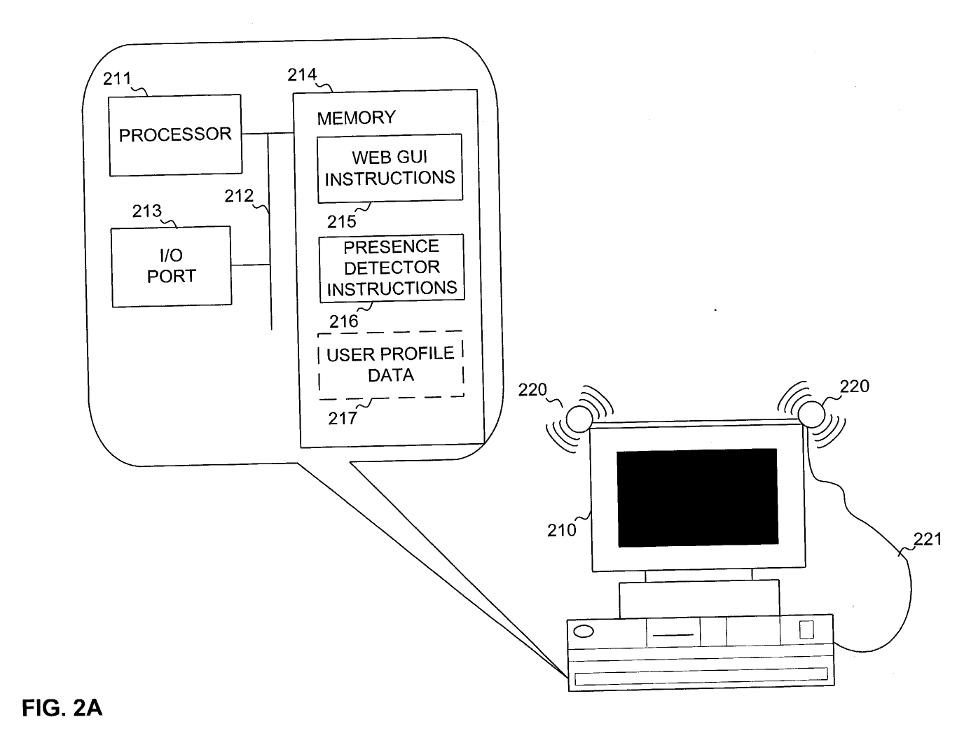

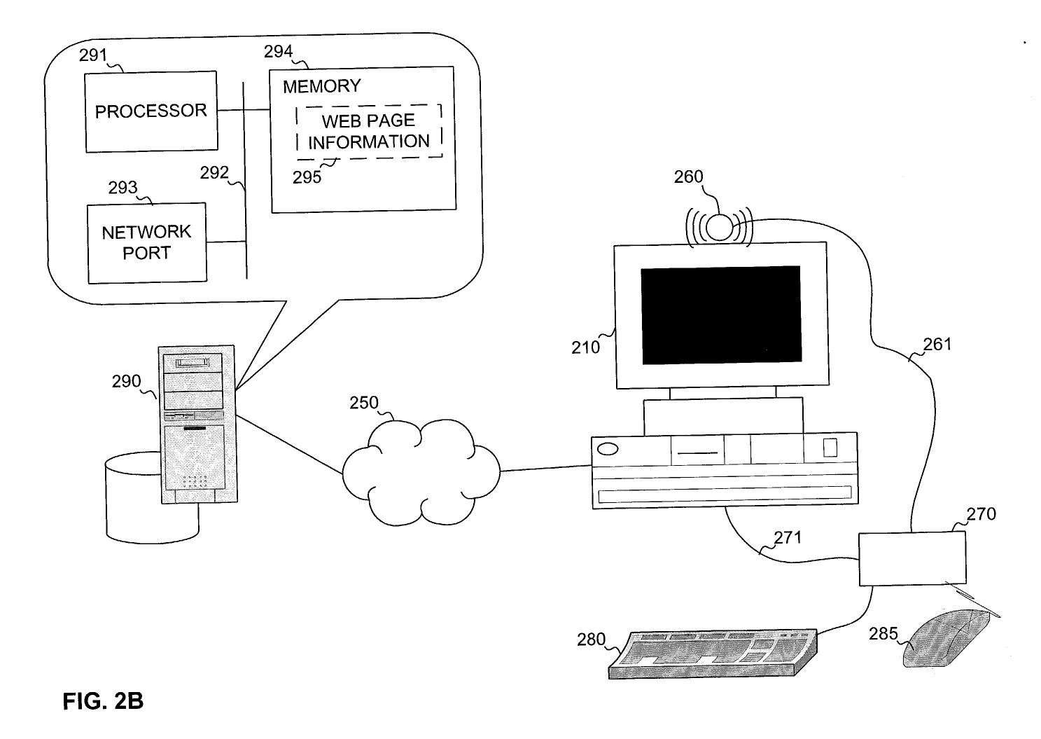

FIG. 2A is a schematic diagram of an embodiment of the present invention. A computer 210 can be coupled to one or more presence detectors 220 via an interface cable 221. In an embodiment, computer 210 includes a processor 211 coupled via bus 212 to an I/O port 213 and a memory 214. Processor 211 can be, for example, an Intel Pentium® 4 processor, manufactured by Intel Corp. of Santa Clara, Calif. As another example, processor 211 can be an Application Specific Integrated Circuit (ASIC). An example of bus 112 is a peripheral component interconnect (“PCI”) local bus, which is a high performance bus for interconnecting chips (e.g., motherboard chips, mainboard chips, etc.), expansion boards, processor/memory subsystems, and so on. Examples of I/O port 213 include a serial port, a parallel port, a Universal Serial Bus (“USB”) port, Institute of Electrical and Electronics Engineers, Inc. (“IEEE”) 1394 port, a PS/2 connector port, a mouse port, a keyboard port, a network port, and so on. In an embodiment, the I/O port 213 is part of an interface card that can be attached to a motherboard of a computer. Memory 214 may be a random access memory (RAM), a dynamic RAM (DRAM), a static RAM (SRAM), a volatile memory, a non-volatile memory, a flash RAM, polymer ferroelectric RAM, Ovonics Unified Memory, magnetic RAM, a cache memory, a hard disk drive, a magnetic storage device, an optical storage device, a magneto-optical storage device, or a combination thereof. Memory 214 of computer 210 can store a plurality of instructions configured to be executed by processor 211.

As used to describe embodiments of the present invention, the term “coupled” encompasses a direct connection, an indirect connection, or a combination thereof. Two devices that are coupled can engage in direct communications, in indirect communications, or a combination thereof. Moreover, two devices that are coupled need not be in continuous communication, but can be in communication typically, periodically, intermittently, sporadically, occasionally, and so on.

Memory 214 can include client-side web GUI instructions 215 (e.g., a web browser) that can manage at least in part communications between computer 210 and a world wide web server. Examples of client-side web graphical user interface instructions include Internet Explorer 5.0 (or another version) from Microsoft Corporation of Redmond, Wash. and Netscape Navigator 4.72 (or another version) from Netscape Communications of Mountain View, Calif. A user can configure web GUI instructions 215 to display a home page (e.g., a page that is displayed when web GUI instructions 215 are first executed, a page that is displayed when a user selects and activates a Home button, etc.). Web GUI instructions 215 can also include instructions to refresh a displayed web page (e.g., by requesting that the server that sent the displayed web page resend the displayed web page information).

In an embodiment, memory 214 can also include presence detector instructions 216 that can receive a presence indication based at least in part on signal generated by presence detectors 220 via interface cable 221 when a person is detected in the vicinity of computer 210. Presence detector instructions 216 can determine whether computer 210 is to take an action based at least in part on the received presence indication. For example, a user can configure the presence detector instructions 216 so that the computer 210 takes no action when a person is detected in the vicinity of computer 210. In another embodiment, the presence detector instructions 216 can be configured to send a command (or a request, an instruction, and so on) to web GUI instructions 215 to request and display the web page that the user has established as his home page. In a further embodiment of the present invention, the presence detector instructions 216 can be configured to send a command to web GUI instructions 215 to refresh the web page that is currently displayed by the web GUI instructions 215.

Presence detector instructions 216, in an embodiment, can be configured to direct an action in response to receiving a presence indication from presence detectors 220. A user can configure the presence detector instructions to direct launching (e.g., executing) of a specific application in response to receiving a presence indication. For example, the user can configure the presence detector instructions 216 to direct launching of typical applications such as an e-mail program, a telephone dialer, an audio compact disc (“CD”) player, an Motion Pictures Expert Group (“MPEG”) level-3 (“MP3”) player, an instant messaging (“IM”) application, a web browser, a document management program, a personal information manager (“PIM”), a word processor, a spreadsheet program, a presentation program, a graphics program, an Internet Server Provider (“ISP”) connectivity program, a modem dialer, and so on. As another example, a user can configure the presence detector instructions 216 to direct an action of an application in response to receiving a presence indication. For example, the user can configure the presence detector instructions 216 to send and/or receive mail in an e-mail application, refresh a database view of a database program, sound an alert (e.g., a chime, a ring, etc.) if a new message (e.g., an e-mail message, a voice mail message, a video message, a facsimile message, an IM message, and so on) has been received but not accessed (e.g., opened, played, etc.) by the user, and so on.

In an embodiment of the present invention, the presence detector instructions 216 can be configured to direct an action based at least in part on a received presence indication and the time/date of the received presence indication. For example, when the presence detector instructions 216 receive a presence indication during a weekday morning time period (e.g., between 4:00 am and 9:00 am), the presence detector instructions 216 can direct retrieving of messaging information and direct the web GUI instructions 215 to retrieve weather information, retrieve traffic information, and so on. As another example, when the presence detector instructions 216 receive a presence indication during a weekday evening time period (e.g., between 5:00 pm and 8:00 pm), the presence detector instructions 216 can direct retrieving of messaging information, direct displaying and/or printing the next day's schedule from a PIM program, and direct the web GUI instructions 215 to retrieve entertainment information (e.g., television and movie schedules), retrieve evening news information, and so on.

For example, Table 1 below illustrates actions that can be taken when a presence indicator is received from one or more presence detectors.

TABLE 1

| Day | Time | Action(s) |
|---|---|---|
| Weekday | 4:00 am to 9:00 am | Retrieve and send e-mail; |
| | | retrieve voice mail |
| | | messages; retrieve traffic |
| | | information; retrieve |
| | | weather information, etc. |
| Weekday | 5:00 pm to 8:00 pm | Retrieve and send e-mail |
| | | messages; retrieve voice |
| | | mail messages; print next |
| | | day's schedule; retrieve |
| | | entertainment information; |
| | | retrieve evening news |
| | | information. |
| . | . | . |
| . | . | . |
| . | . | . |
| Weekend | 6:00 am to 10:00 am | Retrieve and send e-mail |
| | | messages; retrieve weather |
| | | information. |
| Saturday | 4:00 pm to 9:00 pm | Retrieve and send e-mail |
| | | messages; retrieve |
| | | entertainment information. |
| Sunday | 4:00 pm to 9:00 pm | Retrieve and send e-mail |
| | | messages; retrieve voice |
| | | mail messages; print next |
| | | day's schedule. |

In an embodiment of the present invention, memory 214 can include user profile data 217, which can include data of the type illustrated in the above table.

In a further embodiment of the present invention, the presence detector instructions 216 can be configured to deactivate a screen saver (so the user can see the displayed screen) in response to receiving a presence indication. In a further embodiment, receiving a presence indication can cause the presence detector instructions to instruct the computer 210 to exit a hibernation mode (i.e., a standby mode, a power-saving mode, etc.) if the computer 210 is in a hibernation mode.

In an embodiment, computer 210 is an Internet appliance (e.g., a web appliance) that can connect to the Internet to request and/or receive, among other things, data updates. In an embodiment, data updates can be manually directed by selecting and activating a refresh button but automated updates can provide an enhanced user experience. Automated updates can be provided by coupling (e.g., connecting, integrating, and so on) a presence detector to the Internet appliance. When the presence detector senses that a user is in the vicinity of the Internet appliance, a refresh command can be triggered to retrieve updated data, if any.

According to an embodiment of the present invention, presence detector 220 can be an identity detector. For example, an identity detector can be an RFID reader that transmits an activation signal. When an RFID transponder (e.g., a tag, a data card, a wearable data card, etc.) associated with a user receives the activation signal, it can send an identification signal to the RFID reader. An RFID transponder can store a user identifier, and the user identifier can be included in the identification signal to the RFID reader. After the identification signal is received by the RFID reader, it can communicate the identity of the user (e.g., the user identification signal, the user identifier, etc.) to the presence detector instructions 216. The presence detector instructions 216 can access user profile data 217 to determine what action, if any, is to be directed in response to the user's presence.

For example, Table 2 below illustrates actions that can be taken when a user identity is communicated to presence detector instructions 216. In an embodiment, if there is no information delivery action corresponding to an identified user (e.g., a user C), the information delivery action can be to take no action (e.g., leave a screen saver running, fail to refresh a web browser, etc.), to deny the identified user access to the computer, and so on.

TABLE 2

| User | Day | Time | Action(s) |
|---|---|---|---|
| A | Weekday | 4:00 am to | Retrieve and send e-mail of user A; |
| | | 9:00 am | retrieve voice mail messages of user A; |
| | | | retrieve traffic information; retrieve |
| | | | weather information. |
| B | Weekday | 6:00 am to | Retrieve and send e-mail of user B; |
| | | 10:00 am | retrieve weather information; retrieve |
| | | | morning news information. |
| B | Weekday | 10:00 am to | Retrieve and send e-mail of user B; |
| | | 8:00 pm | retrieve news information. |
| A | Weekday | 5:00 pm to | Retrieve and send e-mail |
| | | 8:00 pm | messages of user A; retrieve voice |
| | | | mail messages of user A; print next |
| | | | day's schedule; retrieve entertainment |
| | | | information; retrieve evening news |
| | | | information. |
| | . | . | . |
| | . | . | . |
| | . | . | . |
| A | Weekend | 6:00 am to | Retrieve and send e-mail messages of |
| | | 10:00 am | user A; retrieve weather information. |
| B | Weekend | 6:00 am to | Retrieve and send e-mail messages of |
| | | 10:00 pm | user B; retrieve sports entertainment |
| | | | information. |
| A | Saturday | 4:00 pm to | Retrieve and send e-mail messages of |
| | | 9:00 pm | user A; retrieve entertainment |
| | | | information. |
| A | Sunday | 4:00 pm to | Retrieve and send e-mail messages of |
| | | 9:00 pm | user A; retrieve voice mail messages of |
| | | | user A; print next day's schedule. |

FIG. 2B is a schematic diagram of another embodiment of the present invention. Computer 210 includes a presence detector 260 that is coupled to an interface unit 270 via a communications link 261. Interface unit can be coupled to computer 210 in series with keyboard 280 and/or mouse 285. When presence detector 260 determines that a user is in the vicinity of the computer 260 (e.g., in front of the computer, in the same room as the computer, approaching the computer, etc.), the presence detector 260 can send a signal to interface unit 270. Interface unit 270 can send a presence indicator (e.g., a generic user indicator, a specific user indicator, etc.) to computer 210 via communications link 271. In an embodiment of the present invention, interface unit 270 can send a keyboard signal and/or a mouse signal to computer 210 when it receives a presence indicator from presence detector 260. Examples of keyboard signals and/or mouse signals that can be sent include a mouse movement signal (e.g., to deactivate a screen saver), a string of characters to refresh a current page (e.g., ctrl-R), a string of character to open a predetermined web page in a new display window (e.g., ctrl-O followed by a Universal Resource Locator (“URL”), and so on.

For example, when computer 210 is to open a predetermined web page in a new display window, computer 210 can communicate via network 250 with server 290. Examples of network 250 include a Wide Area Network (WAN), a Local Area Network (LAN), the Internet, a wireless network, a wired network, a connection-oriented network, a packet network, an Internet Protocol (IP) network, or a combination thereof. Server 290 can include a processor 291 coupled via bus 292 to network port 293 and memory 294. Network port 293 can be an Ethernet port, a serial port, a parallel port, a USB port, an IEEE 1394 port, a Small Computer Systems Interface (“SCSI”) port, a Personal Computer Memory Card International Association (“PCMCIA”) port, and so on In an embodiment, memory 294 can include web page information 295. Server 294 can receive a request for web page information 295 from computer 210 and send web page information 295 to computer 210. The server may update web page information 295 periodically. When presence detector 260 determines that a user is in the vicinity of computer 210, computer 210 can request that web page information 295 be sent to computer 210 so that the most recent version of web page information 295 is displayed by computer 210.

In a further embodiment of the present invention, server 290 can receive an indication that an identified user is at or near computer 210. The server 290 can update a presence database to indicate that the identified user is at or near computer 210. Other users may have access to the presence database so that they can determine whether the identified user is at or near computer 210. For example, user A may be identified by presence detector 260, and a user A identifier can be sent to computer 210 and then to server 290. Computer 210 can perform an information delivery action based on the user A identifier (e.g., refresh a web browser). Server 290 can update a presence database to indicate that user A is at or near computer 210. The presence database information indicating that user A is at or near computer 210 can be communicated to a computer of user B (e.g., user B's computer can query for the information from server 290, server 290 can send changes in user A presence information to user B's computer, etc.). User B's computer can indicate that user A is at or near computer 210, for example by changing a GUI icon associated with user A (e.g., from red indicating away from computer 210 to green indicating at or near computer 210), by displaying a message (e.g., a pop-up window announcing that user A is at or near computer 210), by making an audio announcement (e.g., “user A is at or near computer 210”), and so on. Accordingly, user B and other users can determine when user A is at or near computer 210 so that they can send an IM, an e-mail message, initiate a Voice-over-Internet Protocol (“VOIP”) call, initiate a telephone call, and so on.

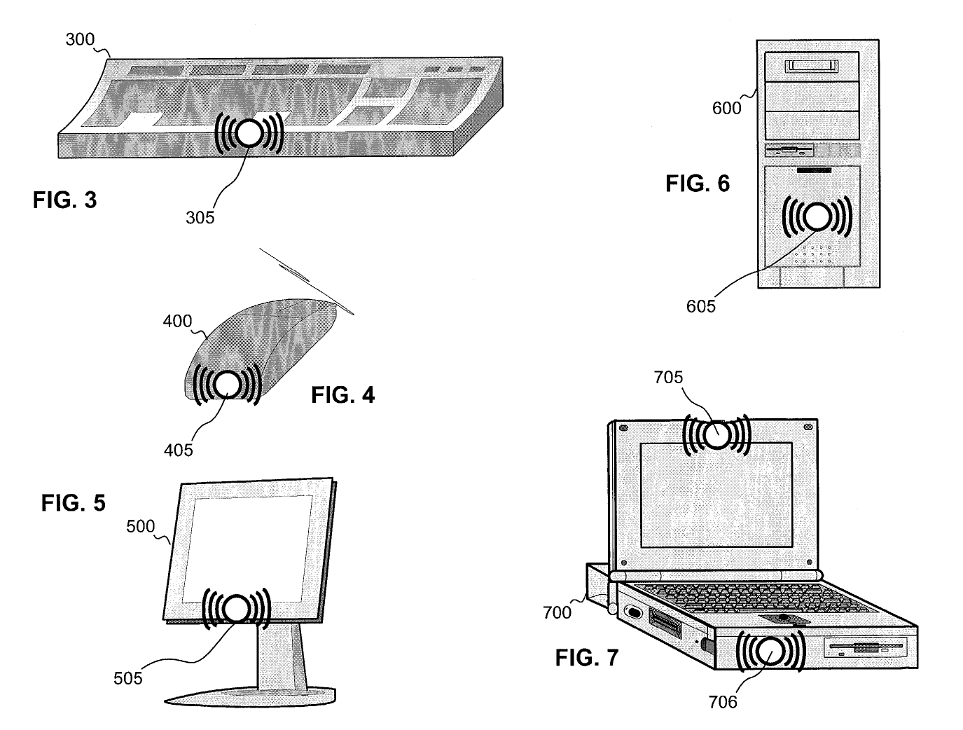

FIGS. 3 through 6 are schematics diagrams of embodiments of the present invention. FIG. 3 is a schematic diagram of a keyboard 300 including a presence detector 305. Keyboard 300 can be coupled to a computer, an internet appliance, a web television interface unit, a video game console, and so on. FIG. 4 is a schematic diagram of a mouse 400 including a presence detector 405. Mouse 400 can be coupled to a computer, an internet appliance, a web television interface unit, and so on. FIG. 5 is a schematic diagram of a video display 500 including a presence detector 505. Video display 500 can be coupled to a computer, included as a component of an internet appliance, coupled to a web television unit, and so on. FIG. 6 is a schematic diagram of a computer 600 including a presence detector 605. Computer 600 can be part of an information delivery system, coupled to the Internet, and so on. FIG. 7 is a schematic diagram of a portable computer 700 including one or more of a presence detector 705 and a presence detector 706. Presence detector 705 can detect the presence and/or identity of a user when the portable computer is opened (e.g., the user is viewing a display integral to the portable computer), and presence detector 706 can detect the presence and/or identity of a user when the portable computer is in use and coupled to a docking station (e.g., the user is viewing a display coupled to, but not integral to, the portable computer).

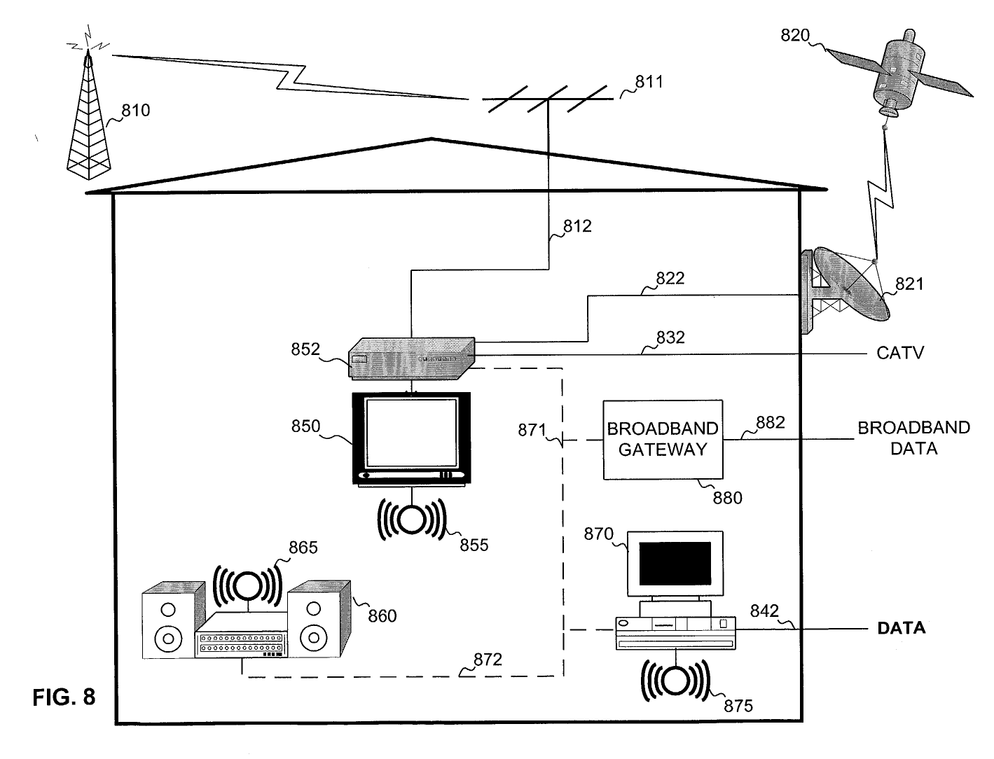

FIG. 8 is a schematic diagram of embodiments of the present invention. A location (e.g., a residence, an office, a house, an apartment, a corporation, etc.) can include one or more information delivery systems. Examples of information delivery systems include audio information delivery systems, video information delivery information systems, audio-video information delivery systems, text delivery systems, graphics delivery systems, facsimile delivery systems, multimedia delivery systems, broadband data delivery systems, a combination thereof, and so on. For example, an audio-video delivery system can include a television 850 coupled to a set top box 852. Set top box 852 can include one or more tuners to receive an information signal from one or more transmission sources and send the information signal to the television 850. Transmissions sources can include a terrestrial television transmitter 810 (e.g., a high definition television (“HDTV”) transmitter, a National Television Standards Committee (“NTSC”) transmitter, etc.) that transmits an audio-video signal to an antenna 811 coupled to set-top box 852 via communications link 812. Another transmissions source can be a satellite transmitter 820 that transmits an information signal (e.g., television signal, audio signal, music signal, etc.) to a satellite dish 821 coupled to set-top box 852 via communications link 822. A further example of a transmission source can be a cable television system coupled to the set-top box 852 via communications link 832. In another embodiment, set-top box 852 can be coupled to broadband gateway 880. Broadband gateway 880 can receive broadband data from a broadband data communications link 882. Examples of broadband data communications link 882 include a broadband-over-copper communications link, a Digital Subscriber Line (“DSL”), a twisted-pair communications link, a fiber-to-the-curb (“FTTC”) communications link, a fiber-to-the-home (“FTTH”) communications link, a satellite communications link, a combination thereof, and so on. Broadband gateway 880 can receive broadband data from the broadband data communications link 882 and communicate with the appropriate information delivery system (e.g., audio information to the stereo system 860 or computer 870, audio-video information to set-top box 852 or computer 870, etc.).

A presence detector 855 can be coupled to television 850 and/or set-top box 852. In an embodiment, the presence detector 855 is integral to the television 850 and/or the set-top box 852. When the presence detector 855 determines that a user is in the vicinity of television 850 it can send a presence indication to the television 850 and/or the set-top box 852 and an information delivery action can be taken based at least in part on the presence indication. For example, Table 3 below illustrates actions that can be taken when a presence indicator is received from one or more presence detectors. In an embodiment in which the presence detector is an identity detector, an information delivery action also can be taken at least in part based on the user identity.

TABLE 3

| User | Day | Time | Action(s) |
|---|---|---|---|
| A | Weekday | 4:00 | Direct turning on television; direct adjusting |
| | | am to | volume to low volume; direct tuning to |
| | | 9:00 | traffic reporting channel; set television |
| | | am | power-off timer to 10 minutes. |
| B | Weekday | 6:00 | Direct turning on television; direct adjusting |
| | | am to | volume to medium volume; direct tuning to |
| | | 10:00 | weather channel; set television power-off |
| | | am | timer to 15 minutes. |
| B | Weekday | 10:00 | Direct turning on television; direct adjusting |
| | | am to | volume to medium volume; direct tuning to a |
| | | 8:00 | news channel; set television to power-off |
| | | pm | timer to 5 minutes. |
| A | Weekday | 5:00 | Direct turning on television; direct adjusting |
| | | pm to | volume to medium volume; direct tuning to |
| | | 7:59 | news channel; set television to power-off |
| | | pm | timer to 20 minutes. |
| A | Monday | 8:00 | Direct turning on television; direct adjusting |
| | | pm to | volume to medium volume; direct turning to |
| | | 9:00 | channel XYZ; set television to power-off at |
| | | pm | 9:00 pm. |
| A | Tuesday | 9:00 | Direct turning on television; direct adjusting |
| | | pm to | volume to medium volume; direct turning to |
| | | 9:30 | channel ZYX; set television to power-off at |
| | | pm | 9:30 pm. |
| B | Tuesday | 9:00 | Direct turning on television; direct adjusting |
| | | pm to | volume to medium volume; direct turning to |
| | | 10:00 | channel CBA; set television to power-off at |
| | | pm | 10:00 pm. |
| . | . | . | . |
| . | . | . | . |
| . | . | . | . |
| A, B | Weekend | 6:00 | Direct turning on television; direct adjusting |
| | | am to | volume to medium volume; direct tuning to |
| | | 10:00 | weather channel; set television power-off |
| | | pm | timer to 15 minutes. |

In an embodiment, conflict determination rules can be configured to indicate which of two or more actions are to be taken when they are in conflict. For example, in Table 3 above, there is a potential for a conflict between the information delivery actions set for Tuesday evening for user A and user B. In an embodiment, whichever action is first triggered is the predominant action. In another embodiment, user A's Tuesday evening action predominates over user B's Tuesday evening action. In a further embodiment, user B's actions always predominate over user A's action. In another embodiment, when a conflict between information delivery actions is detected, an information delivery system can query (e.g., audibly, visually, a combination thereof, etc.) as to which information delivery action should be undertaken (e.g., “Shall the television channel be changed?”) and a user can reply to the query (e.g., “No.”).

Stereo system 860 is an example of an audio information delivery system. Other examples include a radio receiver, a CD player, a cassette tape player, an audio DVD player, and so on. Stereo system 860 can be coupled to a presence detector 865 that can determine when a user is in the vicinity of the stereo system 860. In an embodiment, the presence detector 865 is an integrated component of the stereo system 860. When presence detector 865 determines that a user (e.g., any user, an identified user, etc.) is in the vicinity of stereo system 860, it can send a presence indication to the stereo system 860 and an information delivery action can be taken based at least in part on the presence indication. For example, the table below illustrates actions that can be taken when a presence indicator is received from one or more presence detectors. In an embodiment in which the presence detector is an identity detector, an information delivery action also can be taken at least in part based on the user identity.

TABLE 4

| User | Day | Time | Action(s) |
|---|---|---|---|
| A | Weekday | 6:00 | Turn on stereo system; adjust volume to low |
| | | am to | volume; tune to station 105.1 FM. |
| | | 8:00 | |
| | | am | |
| B | Weekday | 7:00 | Turn on stereo system; adjust volume to |
| | | am to | medium volume; tune to station 99.1 FM. |
| | | 9:00 | |
| | | am | |
| . | . | . | . |
| . | . | . | . |
| . | . | . | . |
| A | Weekend | 6:00 | Turn on stereo system; adjust volume to |
| | | am to | medium volume; tune to station 103.3 FM. |
| | | 10:00 | |
| | | am | |
| B | Weekend | 8:00 | Turn on stereo system; adjust volume to |
| | | am to | medium high volume; tune to station 95.5 |
| | | 12:00 | FM. |
| | | am | |

In another embodiment, computer 870 is coupled to a presence detector 875 and a data communications link 842. Examples of data communications link 842 include a phone line, a cable modem line, a DSL line, a wired communications link coupled to a wireless data transceiver, and so on. In accordance with other embodiments of the present invention, computer 870 can include presence detector instructions and user profile data to direct actions when presence detector 875 determines that a user is in the vicinity of computer 870. In an embodiment of the present invention, computer 870 can be a home entertainment server that is coupled to television 850, set-top box 852, stereo system 860, and other information delivery systems. For example, computer 870 can be coupled to stereo system 860 via communications link 872 and to television 850/set-top box 852 via communications link 871. Communications links 871 and/or 872 can be one of a wireless LAN communications link, a wired LAN communications link, and so on. In an embodiment, when presence detector 855 determines that a user is in the vicinity of television 850, the presence detector 855 can send a presence indicator to computer 870. Computer 870 can determine whether any information delivery action is to be taken based at least in part on the presence indicator and the source of the presence indicator and send an information delivery action, if any, to television 850/set-top box 852.

Computer 870 can also resolve conflicts between potentially conflicting information delivery actions. For example, in an embodiment, stereo system 860 and television 850/set-top box 852 are in the same room. One or more users can be detected in the vicinity of stereo system 860 and television 850. The user profile data of computer 870 can specify which action is to be taken when there are two or more conflicting information delivery actions so that stereo system 860 and television 850 are not to power on and delivery conflicting information (e.g., a television show and music) at the same time. In another embodiment, an information delivery action may instruct that each of television 850 and stereo system 860 power on together so that video information is display on television 850 and audio information corresponding to the video information is played by stereo system 860.

In an embodiment, computer 870 can be coupled to an identity detector and include user profile data that determines who can access certain applications. For example, the identity detector (e.g., an RFID detector, a CCD camera coupled to facial recognition logic, etc.) can determine the identity of the user in the immediate vicinity of the computer and determine whether any information delivery action is to be taken. For example, certain users may be denied access to the computer, access to the computer can be metered and cutoff after an amount of access is exceed (e.g., an aggregate amount, a periodic amount, etc.), and so on. In an embodiment, a child can be allowed 10 hours of web access a week, and after the child has used the computer for 10 hours during a week the child is denied access to the web.

Embodiments of the present invention relate to data communications via one or more networks. The data communications can be carried by one or more communications channels of the one or more networks. A network can include wired communication links (e.g., coaxial cable, copper wires, optical fibers, a combination thereof, and so on), wireless communication links (e.g., satellite communication links, terrestrial wireless communication links, satellite-to-terrestrial communication links, a combination thereof, and so on), or a combination thereof. A network can be circuit-switched, packet-switched, a combination thereof, and so on. A communications link can include one or more communications channels, where a communications channel carries communications. For example, a communications link can include multiplexed communications channels, such as time division multiplexing (“TDM”) channels, frequency division multiplexing (“FDM”) channels, code division multiplexing (“CDM”) channels, wave division multiplexing (“WDM”) channels, a combination thereof, and so on.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Embodiments of presence recognition information delivery systems and methods have been described. In the foregoing description, for purposes of explanation, numerous specific details are set forth to provide a thorough understanding of the present invention. It will be appreciated, however, by one skilled in the art that the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the present invention.

In the foregoing detailed description, systems and methods in accordance with embodiments of the present invention have been described with reference to specific exemplary embodiments. Accordingly, the present specification and figures are to be regarded as illustrative rather that restrictive.

1. A system for remote presence recognition information delivery, the system comprising:
an information delivery system; and
a remote presence detector coupled to the information delivery system, the remote presence detector configured to send a presence indicator to the information delivery system, the information delivery system configured to take an information delivery action based at least in part on the presence indicator.

2. The system of claim 1, wherein the information delivery system includes a computer, the computer including a network port, the network port to receive information from a network.

3. The system of claim 1, wherein the information delivery system includes a web browser, the web browser to request web page information based at least in part on the presence indicator.

4. The system of claim 1, wherein the remote presence detector is selected from the group consisting of an ultrasonic presence detector, an infrared presence detector, a radio frequency presence detector, and a visible light spectrum detector.

5. The system of claim 4, wherein the visible light spectrum detector is a video camera.

6. The system of claim 5, wherein the video camera includes a charge coupled device.

7. The system of claim 1, further comprising user profile data, the user profile data coupled to the information delivery system.

8. The system of claim 7, wherein the information delivery system is configured to take an information delivery action based at least in part on the presence indicator and the user profile data.

9. The system of claim 1, wherein the remote presence detector includes a remote identity detector, the remote presence detector configured to send a identity indicator to the information delivery system, the information delivery system configured to take an information delivery action based at least in part on the identity indicator.

10. The system of claim 9, further comprising user profile data, the user profile data coupled to the information delivery system, the user profile data including one or more user identifiers.

11. The system of claim 10, wherein the user profile data includes one or more information delivery action records, each information delivery action record of at least a subset of the one or more information delivery action records including a user identifier field to store a user identifier and an information delivery action instruction field to store an information delivery action instruction.

12. The system of claim 1, wherein the remote presence detector is configured to determine that a user is in the vicinity of the information delivery system while the user is not in physical contact with each of the remote presence detector and the information delivery system.

13. The system of claim 1, wherein the remote presence detector is configured to determine that a user is in the vicinity of the information delivery system when the user is not speaking.

14. The system of claim 1, wherein the remote presence detector is configured to determine that a user is in the vicinity of the information delivery system based at least in part on a user moving from a first location to a second location, each of the first location and the second location being remote from the remote presence detector and the information delivery system.

15. A system for remote presence recognition information delivery, the system comprising:
an information delivery system including
a processor, and
a memory coupled to the processor, the memory storing user profile data and a plurality of instructions configured to be executed by the processor, the plurality of instructions including presence detector instructions; and
a remote presence detector coupled to the information delivery system, the remote presence detector configured to send a presence indicator to the information delivery system, the information delivery system configured to take an information delivery action based at least in part on the presence indicator and the user profile data.

16. The system of claim 15, wherein the user profile data includes one or more information delivery action records, each information delivery action record of at least a subset of the one or more information delivery action records including an information delivery action instruction field to store an information delivery action instruction.

17. The system of claim 16, wherein each information delivery action record of at least a subset of the one or more information delivery action records includes a time field to store at least one of a time value and a time range value.

18. The system of claim 15, wherein the remote presence detector includes a remote identity detector, the remote presence detector configured to send a identity indicator to the information delivery system, the information delivery system configured to take an information delivery action based at least in part on the identity indicator and the user profile data.

19. The system of claim 18, wherein the information delivery system includes a web browser, the web browser to request web page information based at least in part on the identity indicator.

20. The system of claim 18, further comprising a server coupled to the information delivery system, the server to receive user status information, the user status information based at least in part on the identity indicator.

21. The system of claim 15, wherein the information delivery system is selected from the group consisting of a computer, an internet appliance, a web television system, a home entertainment system, an audio system, an audio-video system, a television system, and a stereo system.

22. The system of claim 15, wherein the information delivery system includes a web browser, the web browser to request web page information based at least in part on the presence indicator.

23. A method of remote presence recognition information delivery, the method comprising:
operating a remote presence detector coupled to an information delivery system;
determining that a user is in the vicinity of the information delivery system based at least in part on receiving a presence indicator from the remote presence detector;
accessing user profile data, the user profile data including one or more information delivery action records;
identifying an information delivery action record based at least in part on the presence indicator; and
executing an information delivery action based at least in part on the identified information delivery action record.

24. The method of claim 23, wherein the information delivery system includes:
a processor coupled to a memory, the memory storing instructions configured to be executed by the processor, the processor coupled to a network port, the network port to receive information from a network; and
a web browser, the web browser to request web page information via the network port based at least in part on the presence indicator.

25. The method of claim 23, wherein the remote presence detector is selected from the group consisting of an ultrasonic presence detector, an infrared presence detector, a radio frequency presence detector, and a visible light spectrum detector.

26. The method of claim 25, wherein the visible light spectrum detector includes a charge coupled device.

27. The method of claim 23, wherein:
the remote presence detector includes a remote identity detector;
determining that the user is in the vicinity of the information delivery system is based at least in part on receiving an identity indicator from the remote presence detector; and
identifying the information delivery action record based at least in part on the presence indicator includes identifying the information delivery action record based at least in part on the identity indicator.

28. The method of claim 27, wherein each information delivery action record of at least a subset of the one or more information delivery action records including a user identifier field to store a user identifier and an information delivery action instruction field to store an information delivery action instruction.

29. The method of claim 23, wherein the remote presence detector is configured to determine that the user is in the vicinity of the information delivery system while the user is not in physical contact with each of the remote presence detector and the information delivery system.

30. The method of claim 23, wherein the remote presence detector is configured to determine that the user is in the vicinity of the information delivery system when the user is not speaking.

31. The method of claim 23, wherein the remote presence detector is configured to determine that a user is in the vicinity of the information delivery system based at least in part on a user moving from a first location to a second location, each of the first location and the second location being remote from the remote presence detector and the information delivery system.

32. A method of delivering information, the method comprising:
storing user profile data, the user profile data including one or more information delivery action records;
determining that a first user is at a first location in the vicinity of an information delivery system, the first location being remote from the information delivery system;
receiving a presence indicator from a remote presence detector, the remote presence detector coupled to the information delivery system;
selecting a first information delivery action record based at least in part on the presence indicator; and
executing a first information delivery action based at least in part on the first information delivery action record.

33. The method of claim 32, wherein the first information delivery action is selected from the group consisting of refreshing a web page, deactivating a screen saver, requesting information from a predetermined network address, requesting e-mail messages, executing an application, powering on the information delivery system, adjusting the volume of an information delivery system, tuning the information delivery system to select a channel, exiting a power-saving mode, exiting a hibernation mode, and sending a user status indicator to a server based at least in part on the presence detector.

34. The method of claim 32, wherein:
receiving a presence indicator from a remote presence detector includes receiving a first identity indicator from an identity detector; and
selecting a first information delivery action record based at least in part on the presence indicator includes selecting a first information delivery action record based at least in part on the first identity indicator.

35. The method of claim 34, wherein the first information delivery action includes determining whether the first user is authorized to receive information from the information delivery system.

36. The method of claim 34, wherein the first information delivery action includes determining whether the first user has exceeded an information delivery access allocation.

37. The method of claim 34, further comprising:
receiving a second identity indicator from the identity detector; and
selecting a second information delivery action record based at least in part on the second identity indicator.

38. The method of claim 37, determining which of the first information delivery action and the second information delivery action has priority over the other.

39. A system for remote presence recognition information delivery, the system comprising:
means for operating a remote presence detector coupled to an information delivery system;
means for determining that a user is in the vicinity of the information delivery system based at least in part on receiving a presence indicator from the remote presence detector;
means for accessing user profile data, the user profile data including one or more information delivery action records;
means for identifying an information delivery action record based at least in part on the presence indicator; and
means for executing an information delivery action based at least in part on the identified information delivery action record.

40. The system of claim 39, wherein:
the remote presence detector includes a remote identity detector;
the means for determining that the user is in the vicinity of the information delivery system based at least in part on receiving the presence indicator from the remote presence detector includes means for determining that the user is in the vicinity of the information delivery system based at least in part on receiving an identity indicator from the remote identity detector; and
the means for identifying the information delivery action record based at least in part on the presence indicator includes means for identifying the information delivery action record based at least in part on the identity indicator.

41. A method for remote presence recognition information delivery, the method comprising:
a step for operating a remote presence detector coupled to an information delivery system;
a step for determining that a user is in the vicinity of the information delivery system based at least in part on receiving a presence indicator from the remote presence detector;
a step for accessing user profile data, the user profile data including one or more information delivery action records,
a step for identifying an information delivery action record based at least in part on the presence indicator; and
a step for executing an information delivery action based at least in part on the identified information delivery action record.

42. The method of claim 41, wherein:
the remote presence detector includes a remote identity detector;
the step for determining that the user is in the vicinity of the information delivery system based at least in part on receiving the presence indicator from the remote presence detector includes a step for determining that the user is in the vicinity of the information delivery system based at least in part on receiving an identity indicator from the remote identity detector; and
the step for identifying the information delivery action record based at least in part on the presence indicator includes a step for identifying the information delivery action record based at least in part on the identity indicator.

43. A computer-readable medium storing a plurality of instructions to be executed by a processor for remote presence recognition information delivery, the plurality of instructions comprising instructions to:
operate a remote presence detector coupled to an information delivery system;
determine that a user is in the vicinity of the information delivery system based at least in part on receiving a presence indicator from the remote presence detector;
access user profile data, the user profile data including one or more information delivery action records;
identify an information delivery action record based at least in part on the presence indicator; and
execute an information delivery action based at least in part on the identified information delivery action record.

44. The computer-readable medium of claim 43, wherein:
the remote presence detector includes a remote identity detector;
the instructions to determine that the user is in the vicinity of the information delivery system based at least in part on receiving the presence indicator from the remote presence detector include instructions to determine that the user is in the vicinity of the information delivery system based at least in part on receiving an identity indicator from the remote identity detector; and
the instructions to identify the information delivery action record based at least in part on the presence indicator includes instructions to identify the information delivery action record based at least in part on the identity indicator.
